(19) United States
(12) Patent Application Publication
(10) Pub. No.: US 2014/0043440 A1
(43) Pub. Date: Feb. 13, 2014

(54) 3D GLASSES, 3D DISPLAY SYSTEM AND 3D DISPLAYING METHOD

(71) Applicant: NVIDIA CORPORATION, Santa Clara, CA (US)

(72) Inventors: Hao Tang, Shenzhen (CN); Shuang Xu, Shenzhen (CN)

(73) Assignee: NVIDIA CORPORATION, Santa Clara, CA (US)

(21) Appl. No.: 13/667,960

(22) Filed: Nov. 2, 2012

(30) Foreign Application Priority Data
Aug. 13, 2012 (CN) 201210287735.8

(51) Int. Cl. H04N 13/04; H04N 13/02

(52) U.S. Cl. 348/47; 348/54; 348/E13.026

(57) ABSTRACT

The present invention provides 3D glasses, a 3D display system and a 3D displaying method. The 3D display system comprises: 3D glasses, comprising a first sensor disposed on the 3D glasses for detecting an action of a head of a wearer and a second sensor disposed on the 3D glasses for detecting an action of an eyeball of the wearer; 3D display device, including a screen for displaying a 3D image; and a controller, for controlling a first operation of the 3D display device according to the action of the head, and controlling a second operation of the 3D display device according to the action of the eyeball. The 3D display system provided by the present invention can control the first and second operation of the 3D display device in response to the action of the head and the eyeball, so as to achieve human-machine interaction without any intermediate device. Therefore, it has the advantage of convenient use, etc.

### CROSS-REFERENCE TO RELATED APPLICATIONS

This application claims priority to Chinese Patent Application No. 201210287735.8, filed on Aug. 13, 2012, which is hereby incorporated by reference in its entirety.

### FIELD OF INVENTION

The present invention relates generally to 3D technology, in particular, to 3D glasses, a 3D display system and a 3D displaying method.

### BACKGROUND

3D technology is more and more widely used in modem life. 3D technology separates the images seen by left and right eyes of a human by means of the principle, that the angles in which two eyes view objects are slightly different so that it is able to distinguish the distance of the objects and form stereo visual effect, so as to make the user experience stereo perception.

Now, people have to interact with a 3D display device by a human-machine interface device, such as a mouse, a keyboard, a joy stick or a remote-control unit. It results in much inconvenience. For example, a viewer cannot see the whole contents in the scene simultaneously when viewing a 3D panorama scenery film, because of the limitation of the size of the 3D display device and the visual angle of the viewer. If the above human-machine interface device is used to move the scene so as to present the area interesting the viewer on the screen of the 3D display device or place the area interesting the viewer in the centre of the screen, the viewing effect would be affected. Especially for seeing a 3D film, the frame rate of 3D display is usually up to 120-240 frames per second. That is to say, if the viewer changes or moves the scene by the human-machine interface device during seeing a 3D film, he may miss 120-240 frames even if the action only spends 1 second. Obviously, it may seriously affect the viewing of the viewer.

Therefore, there is a need of providing 3D glasses, a 3D display system and a 3D displaying method to solve the above problem in the prior art.

In order to solving the above problem, a 3D display system is provided in the present invention, comprising: 3D glasses, comprising a first sensor disposed on the 3D glasses for detecting an action of a head of a wearer and a second sensor disposed on the 3D glasses for detecting an action of an eyeball of the wearer; 3D display device, including a screen for displaying a 3D image; and a controller, for controlling a first operation of the 3D display device according to the action of the head, and controlling a second operation of the 3D display device according to the action of the eyeball.

Preferably, the first operation comprises moving a scene on the screen in response to the action of the head.

Preferably, the second operation comprises finding an object to be operated on the screen in response to the action of the eyeball.

Preferably, the second operation also comprises operating the object to be operated in response to stay time of the eyeball.

Preferably, the 3D display system also comprises an audio sensor disposed on the 3D glasses, for detecting sound made by the wearer, the controller controls a third operation of the 3D display device according to the sound.

Preferably, the third operation comprises operating an object to be operated on the screen in response to the sound.

Preferably, the audio sensor is a skull microphone.

Preferably, the first sensor is a 6-channel acceleration transducer.

Preferably the second sensor comprises an infrared ray LED light and a micro camera, wherein the infrared ray LED light is used for lighting the eyeball of the wearer, and the micro camera is used for detecting the action of the eyeball.

3D glasses are provided in the present invention, comprising: a first sensor disposed on the 3D glasses, for detecting an action of a head of a wearer; and a second sensor disposed on the 3D glasses, for detecting an action of an eyeball of the wearer.

Preferably, the first sensor is a 6-channel acceleration transducer.

Preferably, the second sensor comprises an infrared ray LED light and a micro camera, wherein the infrared ray LED light is used for lighting the eyeball of the wearer, and the micro camera is used for detecting the action of the eyeball.

Preferably, the 3D glasses also comprise an audio sensor disposed on the 3D glasses, for detecting sound made by the wearer.

Preferably, the audio sensor is a skull microphone.

A 3D displaying method is provided in the present invention, comprising: displaying a 3D image on a screen of a 3D display device; detecting an action of a head of a wearer of 3D glasses; detecting an action of an eyeball of the wearer; and controlling a first operation of the 3D display device according to the action of the head, and controlling a second operation of the 3D display device according to the action of the eyeball.

Preferably, the first operation comprises moving a scene on the screen in response to the action of the head.

Preferably, the second operation comprises finding an object to be operated on the screen in response to the action of the eyeball.

Preferably, the second operation also comprises operating the object to be operated in response to stay time of the eyeball.

Preferably, the 3D displaying method also comprises detecting sound made by the wearer, and controlling a third operation of the 3D display device according to the sound.

Preferably, the third operation comprises operating an object to be operated on the screen in response to the sound.

The 3D display system provided by the present invention can control the first and second operations of the 3D display device in response to the actions of the head and the eyeball, so as to achieve human-machine interaction without any intermediate device. Therefore, it has the advantage of convenient use, etc.

A serial of simplified conceptions are incorporated into the summary of the invention, which will be further described in more detail in the detailed description. The summary of the invention neither implies that it is intended to limit the essential features and necessary technical features of the technical solution to be protected, nor implies that it is intended to define the protection scope of the technical solution to be protected.

Advantages and features of the present invention will be described in detail below in connection with the accompanying drawings.

### BRIEF DESCRIPTION OF THE DRAWINGS

The following drawings of the present invention as a part of the present invention herein are used for understanding of the present invention, the embodiments and the descriptions thereof are illustrated in the drawings for explaining the principle of the present invention. In the drawings,

FIG. 1 is a schematic view of the 3D display system according to one embodiment of the invention;

FIG. 2 is a schematic view of the 3D glasses according to one embodiment of the invention;

FIG. 3 is a schematic view of the 3D glasses according to another embodiment of the invention; and

FIG. 4 is a flow chart of a 3D displaying method according to one embodiment of the invention.

### DETAILED DESCRIPTION

A plenty of specific details are presented so as to provide more thoroughly understanding of the present invention in the description below. However, the present invention may be implemented without one or more of these details, as is obvious to those skilled in the art. In other examples, some of the technical features known in the art are not described so as to avoid confusions with the present invention.

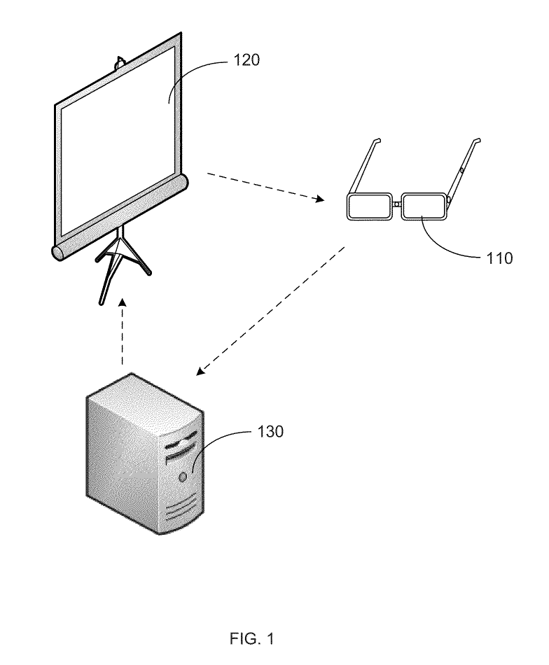

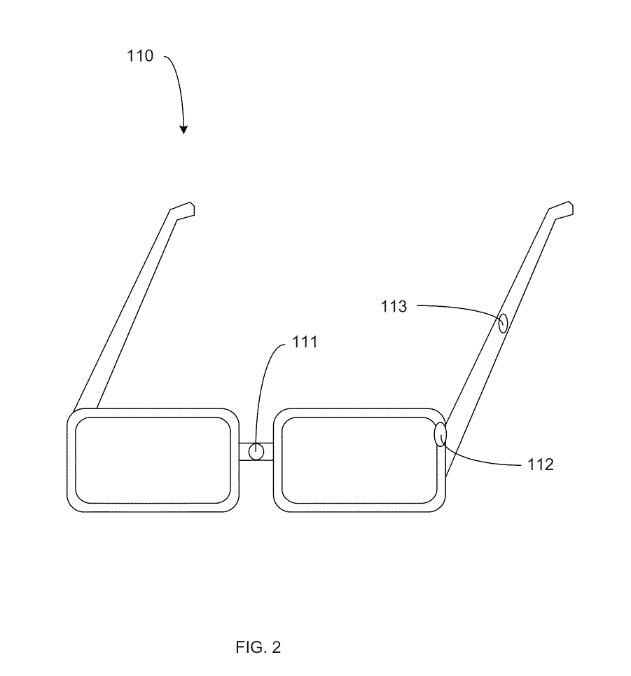

A 3D display system is provided in the invention. Using the 3D display system, the viewer may perform human-machine interaction conveniently. FIG. 1 illustrates the 3D display system according to one embodiment of the invention, and FIG. 2 illustrates the 3D glasses according to one embodiment of the invention. Below, the 3D display system and the 3D glasses included therein will be described in detail by combining with FIGS. 1-2. As shown in FIG. 1, the 3D display system basically comprises 3D glasses 110, a 3D display device 120 and a controller 130.

As shown in FIG. 2, the 3D glasses 110 comprise a first sensor 111 and a second sensor 112. Other components comprised in the 3D glasses 110 may be the same as the 3D glasses in the prior art, such as, glasses frame, left and right LCD lenses, a microcontroller for alternately controlling the open of left and right LCD lenses, a power supply and a synchronized signal receiver. They will be not described in detail, since the components are known by those skilled in the art.

The first sensor 111 is disposed on the 3D glasses 110, for detecting the action of the head of the wearer. The action of the head may include the movement and rotation of the head, etc. The first sensor 111 may be any sensor being able to detect the action of the head of the wearer. As an example, the first sensor 111 may be disposed on the connecter between two eyeglasses on the 3D glasses 110 (as shown in FIG. 2), or disposed on the other positions on the 3D glasses 110 as long as it is able to achieve the function. In order to accurately detecting the movement of the head in X, Y and Z directions and the rotation of the head on X, Y and Z planes, preferably, the first sensor 111 is a 6-channel acceleration transducer.

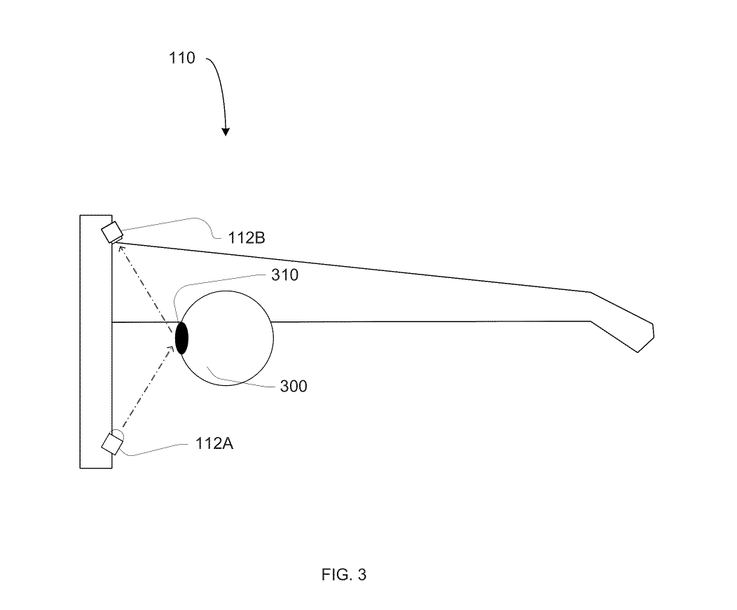

The second sensor 112 is disposed on the 3D glasses 110, for detecting the action of the eyeball of the wearer. The action of the eyeball may include the rotation of the eyeball, etc. The second sensor 112 may be any sensor being able to detect the action of the eyeball of the wearer. As an example, the second sensor 112 may be disposed on the glasses frame on the 3D glasses 110 (as shown in FIG. 2), or disposed on the other positions on the 3D glasses 110 as long as it is able to achieve the function. Sometimes, the 3D display system is used to view the 3D image in the environment which is relatively dark. In order to accurately detect the action of the eyeball in any environment, preferably, as shown in FIG. 3, the second sensor 112 comprises an infrared ray LED light 112A and a micro camera 112B. The infrared ray LED light 112A is used for lighting an eyeball 300 of the wearer (specifically, pupil 310), and the micro camera 112B is used for detecting the action of the eyeball 300. It needs to explain that the positions of the infrared ray LED light 112A and a micro camera 112B can be changed according to actual requirement (e.g. according to the concrete structure of the 3D glasses 110, etc.), as long as they are able to achieve the functions of them. It is not intended to limit the positions of the infrared ray LED light 112A and a micro camera 112B in the present invention.

Returning to FIG. 1, the 3D display device 120 comprises a screen for displaying the 3D image. The 3D display device 120 may be any type of display device which can display 3D images, such as, liquid crystal displays (LCD) and opaque projectors, etc.

The controller 130 controls the first operation of the 3D display device 120 according to the action of the head, and controls the second operation of the 3D display device 120 according to the action of the eyeball. The detected signal of the action of the head and the detected signal of the action of the eyeball may be sent from the first sensor 111 and the second sensor 112 to the controller directly, or may be sent to the 3D display device 120 and then sent to the controller 130 by the 3D display device 120. Although, the 3D display device 120 and the controller 130 are separated components as shown in FIG. 1, they may be integrated with each other.

As an example, the first operation may comprise moving a scene on the screen of the 3D display device 120 in response to the action of the head. For example, according to the directions of the movement and rotation of the head, the scene involved in the directions is dragged to the centre of the screen. In this way, the action of the head can be used to move the scene when one see a film and play game, such that the human-machine interaction can be achieved without any intermediate device. Especially when seeing a panorama scenery film or playing a first person shooting game, one would have an immersed sense.

As an example, the second operation may comprise finding an object to be operated on the screen in response to the action of the eyeball. For example, the eyeball is equivalent to a mouse, and the movement of the eyeball is equivalent to the movement of the mouse. The reflection on the screen is that the cursor moves to the position where the eyes stare at. Preferably, the second operation also comprises operating the object to be operated in response to stay time of the eyeball. For example, it can be set that when the stay time of the eyeball is 3 seconds (or less than 3 seconds, or more than 3 seconds), it is equivalent to clicking the object to be operated. As an example, when seeing a film, one may move the eyeball to find the frame of the video window, stay the eyeball for 3 seconds to popup the frame, move the eyeball to find the button such as play, pause and speed, and stay the eyeball for 3 seconds to perform the corresponding operation.

Of course, the contents of the first operation and the second operation may exchange, or the first operation and the second operation may also have other contents. In this way, the viewer can perform human-machine interaction with the 3D display device through indicating two different kinds of operating contents by the action of the head and the action of the eyeball respectively.

Preferably, the 3D glasses 110 of the 3D display system also comprise an audio sensor 113 (referring to FIG. 2). The audio sensor 113 is disposed on the 3D glasses 110, for detecting the sound made by the wearer. As an example, the audio sensor 113 may disposed on the arm of 3D glasses 110 (as shown in FIG. 2), or disposed on the other positions on the 3D glasses 110 as long as it is able to achieve the function. The controller controls the third operation of the 3D display device 120 according to sound. The third operation may be performed in response to the volume of the sound made by the wearer, or in response to the content of the sound made, i.e. a function of voice recognition. The 3D display system may have more operating manners by adding the audio sensor 113, so as to meet various operating requirements of the wearer. Preferably, the third operation may comprise operating an object to be operated on the screen of the 3D display device 120 in response to the sound made by the wearer, for example, performing the operation of click or double-click. As an example, when playing the first person shooting game, one may control the shooting by the sound. In order to avoid the interference t e sound in the environment, preferably, the audio sensor 113 may be a skull microphone.

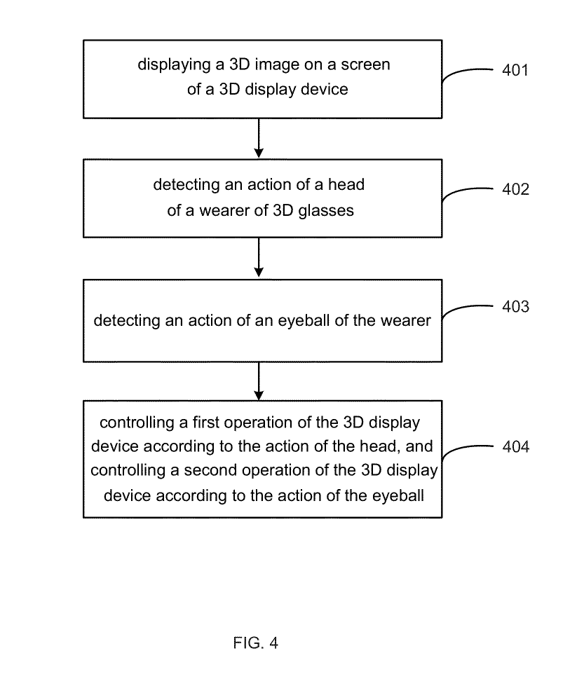

A 3D displaying method is provided in the present invention. FIG. 4 shows the flow chart of the method. The method of the invention will be described by combining with FIG. 4 below.

Firstly, perform step 401, displaying a 3D image on a screen of a 3D display device.

Then, perform step 402, detecting an action of a head of a wearer of 3D glasses. For example, detect the movement and rotation of the head.

Then, perform step 403, detecting an action of an eyeball of the wearer. For example, detect the rotation of the eyeball.

Finally, perform step 404, controlling a first operation of the 3D display device according to the action of the head, and controlling a second operation of the 3D display device according to the action of the eyeball.

As an example, the first operation may comprise moving a scene on the screen in response to the action of the head. For example, according to the directions of the movement and rotation of the head, the scene involved in the directions is dragged to the centre of the screen. In this way, one can move the scene by the action of the head when seeing a film and playing game, such that human-machine interaction can be achieved without any intermediate device.

As an example, the second operation may comprise finding an object to be operated on the screen in response to the action of the eyeball. For example, the eyeball is equivalent to a mouse, and the movement of the eyeball is equivalent to the movement of the mouse. The reflection on the screen is that the cursor moves to the position where the eyes stare at. Preferably, the second operation also comprises operating the object to be operated in response to stay time of the eyeball. For example, it can be set that when the stay time of the eyeball is 3 seconds (or less than 3 seconds, or more than 3 seconds), it is equivalent to clicking the object to be operated. As an example, when seeing a film, one may move the eyeball to find the frame of the video window, stay the eyeball for 3 seconds to popup the frame, move the eyeball to find the button such as play, pause and speed, and stay the eyeball for 3 seconds to perform the corresponding operation.

Preferably, the method also comprises detecting sound made by the wearer, and controlling a third operation of the 3D display device according to the sound. The third operation may be performed in response to the volume of the sound made by the wearer, or in response to the content of the sound made, i.e. a function of voice recognition. More operating manners can be provided by performing the third operation in response to the sound made by the wearer, so as to meet various operating requirements of the wearer. The third operation may comprise operating an object to be operated on the screen in response to the sound. For example, perform the operation of click or double-click.

The 3D display system provided by the present invention can control the first and second operations of the 3D display device in response to the actions of the head and the eyeball, so as to achieve human-machine interaction without any intermediate device. Therefore, it has the advantage of convenient use, etc.

The present invention has been described by the above-mentioned embodiments. However, it will be understand that the above-mentioned embodiments are for the purpose of demonstration and description and not for the purpose of limiting the present to the scope of the described embodiments. Moreover, those skilled in the art could appreciated that the present invention is not limited to the above mentioned embodiments and that various modifications and adaptations in accordance of the teaching of the present invention may be made within the scope and spirit of the present invention. The protection scope of the present invention is further defined by the following claims and equivalent scope thereof.

What is claimed is:

1. A 3D display system, characterized by comprising:
3D glasses, comprising:
a first sensor disposed on the 3D glasses, for detecting an action of a head of a wearer; and
a second sensor disposed on the 3D glasses, for detecting an action of an eyeball of the wearer;
a 3D display device, including a screen for displaying a 3D image; and
a controller, for controlling a first operation of the 3D display device according to the action of the head, and controlling a second operation of the 3D display device according to the action of the eyeball.

2. The 3D display system according to claim 1, characterized in that the first operation comprises moving a scene on the screen in response to the action of the head.

3. The 3D display system according to claim 1, characterized in that the second operation comprises finding an object to be operated on the screen in response to the action of the eyeball.

4. The 3D display system according to claim 3, characterized in that the second operation also comprises operating the object to be operated in response to stay time of the eyeball.

5. The 3D display system according to claim 1, characterized in that the 3D display system also comprises an audio sensor disposed on the 3D glasses, for detecting sound made by the wearer, the controller controls a third operation of the 3D display device according to the sound.

6. The 3D display system according to claim 5, characterized in that the third operation comprises operating an object to be operated on the screen in response to the sound.

7. The 3D display system according to claim 5, characterized in that the audio sensor is a skull microphone.

8. The 3D display system according to claim 1, characterized in that the first sensor is a 6-channel acceleration transducer.

9. The 3D display system according to claim 1, characterized in that the second sensor comprises an infrared ray LED light and a micro camera, wherein the infrared ray LED light is used for lighting the eyeball of the wearer, and the micro camera is used for detecting the action of the eyeball.

10. 3D glasses, characterized by comprising:
a first sensor disposed on the 3D glasses, for detecting an action of a head of a wearer; and
a second sensor disposed on the 3D glasses, for detecting an action of an eyeball of the wearer.

11. The 3D glasses according to claim 10, characterized in that the first sensor is a 6-channel acceleration transducer.

12. The 3D glasses according to claim 10, characterized in that the second sensor comprises an infrared ray LED light and a micro camera, wherein the infrared ray LED light is used for lighting the eyeball of the wearer, and the micro camera is used for detecting the action of the eyeball.

13. The 3D glasses according to claim 10, characterized in that the 3D glasses also comprise an audio sensor disposed on the 3D glasses, for detecting sound made by the wearer.

14. The 3D glasses according to claim 13, characterized in that the audio sensor is a skull microphone.

15. A 3D displaying method, characterized by comprising:
displaying a 3D image on a screen of a 3D display device;
detecting an action of a head of a wearer of 3D glasses;
detecting an action of an eyeball of the wearer; and
controlling a first operation of the 3D display device according to the action of the head, and
controlling a second operation of the 3D display device according to the action of the eyeball.

16. The 3D displaying method according to claim 15, characterized in that the first operation comprises moving a scene on the screen in response to the action of the head.

17. The 3D displaying method according to claim 15, characterized in that the second operation comprises finding an object to be operated on the screen in response to the action of the eyeball.

18. The 3D displaying method according to claim 17, characterized in that the second operation also comprises operating the object to be operated in response to stay time of the eyeball.

19. The 3D displaying method according to claim 17, characterized in that the 3D displaying method also comprises detecting sound made by the wearer, and controlling a third operation of the 3D display device according to the sound.

20. The 3D displaying method according to claim 19, characterized in that the third operation comprises operating an object to be operated on the screen in response to the sound.
